(19) United States
(12) Patent Application Publication
(10) Pub. No.: US 2010/0123876 A1
(43) Pub. Date: May 20, 2010

(54) PROJECTOR, AND METHOD OF CONTROLLING PROJECTOR

(75) Inventors: Takeshi Furihata, Okaya-shi (JP); Satoru Nasukawa, Matsumoto-shi (JP); Naoki Hayashi, Matsumoto-shi (JP); Kenichi Kitagawa, Azumino-shi (JP); Yoshiyuki Furumi, Shiojiri-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/620,966

(22) Filed: Nov. 18, 2009

(30) Foreign Application Priority Data
Nov. 20, 2008 (JP) 2008-296689

(51) Int. Cl. G03B 31/00

(52) U.S. Cl. 353/15; 353/121

(57) ABSTRACT

A projector includes: a power supply device; an image projection device having a light source device; a sound processing device adapted to process a sound signal from an external microphone; and a control device adapted to control the power supply device, wherein the control device can selectively set either one of a first operation mode in which the light source device and the sound processing device are made to be supplied with electrical power and a second operation mode in which the sound processing device is made to be supplied with the electrical power while halting supplying the electrical power to the light source device, and the control device controls the electrical power supply by the power supply device to the light source device and the sound processing device based on the operation mode set.

The entire disclosure of Japanese Patent Application No. 2008-296689, filed Nov. 20, 2008 is expressly incorporated by reference herein.

### BACKGROUND

1. Technical Field

The present invention relates to a projector, and a method of controlling a projector.

2. Related Art

In the past, there has been known a projector (an overhead projector), as a projector for enlargedly projecting image light on a screen or the like, collecting a sound with a microphone and outputting the sound thus collected (see, e.g., JP-UM-A-3-58628).

The projector described in JP-UM-A-3-58628 is provided with a sound amplification device and a recording/reproducing device, and records a sound signal input from a microphone on the recording/reproducing device, and at the same time, amplifies the sound signal with the sound amplification device.

Incidentally, in a normal operation mode (in the state in which the image light can be projected by lighting a light source device) in which the power necessary for the operation is supplied to the light source device, the projector generally cools the inside of the projector using a cooling fan or the like in order for preventing a failure in operation of the projector due to heat generation of the light source device.

Therefore, when the user amplifies the voice the user produces using the microphone and the projector, the noise caused by driving the cooling fan or the like is inevitably mixed with the voice.

Therefore, there has been demanded a technology making it possible to use the projector as a loudspeaker without mixing the noise caused by driving the cooling fan or the like, and capable of achieving enhancement of convenience.

### SUMMARY

An advantage of some aspects of the invention is to provide a projector and a method of controlling a projector capable of achieving enhancement of convenience.

A projector according to an aspect of the invention includes a power supply device, an image projection device having a light source device, a sound processing device adapted to process a sound signal from an external microphone, and a control device adapted to control the power supply device, wherein the control device can selectively set either one of a first operation mode in which the light source device and the sound processing device are made to be supplied with electrical power and a second operation mode in which the sound processing device is made to be supplied with the electrical power while halting supplying the electrical power to the light source device, and controls the electrical power supply by the power supply device to the light source device and the sound processing device based on the operation mode set.

Here, the projector of this aspect of the invention can be provided with the configuration incorporating the speaker for outputting the sound in an amplified manner based on the sound signal processed by the sound processing device, or it is also possible to adopt the configuration in which an external speaker is additionally connected to the projector, and the sound based on the sound signal processed by the sound processing device is made to be output in an amplified manner via the external speaker.

Further, by making it possible to set the third operation mode in which the electrical power supply from the power supply device to the light source device and the sound processing device is halted, it is possible to break the operation mode in the standby state into two parts, namely the second operation mode in which the sound output is possible and the third operation mode in which the sound output is not performed, and therefore, it becomes possible to optimize the standby power in accordance with the setting.

Further, in the projector to which this aspect of the invention is applied, the operation mode is determined in accordance with the input of the setting information to the operation device by the user. In other words, by setting the setting information related to the operation mode so as to correspond to the second operation mode, the user can use the projector as the loudspeaker even in the operation mode in which an image is not projected, thus the convenience thereof is enhanced. Further, in the case in which the projector is not used as the loudspeaker in the operation mode in which an image is not projected, the electrical power supply from the power supply device to the sound processing device is halted by setting the setting information related to the operation mode so as to correspond to the third operation mode, and therefore, unnecessary power consumption in the sound processing device and the power supply device can be avoided. It should be noted that as the operation device, for example, an operation panel provided to the exterior housing of the projector and the remote controller can be exemplified. Further, it is also possible to provide a mechanical switch for switching the operation mode to the projector, and to adopt the mechanical switch as the operation device.

Incidentally, in the case in which the user does not use the projector as a loudspeaker, the output plug of the external microphone is not inserted in the microphone jack, in general. On the other hand, it can be supposed that the user forget to pull out the output plug of the external microphone from the microphone jack, and the output plug is left inserted therein. In such a case, if the electrical power is supplied to the sound processing device on the ground only of the detection of the connection state in the connection detection device, the electrical power is supplied from the sound power supply device to the sound processing device irrespective of the fact that the projector is not used as the loudspeaker, and therefore, the power is consumed unnecessarily.

According to the configuration of this aspect of the invention, the operation mode of the control device is set to be either of the first operation mode and the second operation mode, and further, if it is detected to be in the connection state, the control device makes the power supply device supply the sound processing device with the electrical power, and therefore, unnecessary power consumption can be avoided.

Further, in the case in which the operation mode is set to be the third operation mode, by configuring the control device so as to make the power supply device halt supplying the sound processing device with the electrical power regardless of the result of the detection by the connection detection device, the electrical power supply to the sound processing device is cut in the case in which the user does not intend to use the projector as the loudspeaker, and therefore, the wasteful power consumption can reliably be avoided.

Incidentally, there can be supposed the case in which the user does not speak to the external microphone even in the state in which the output plug of the external microphone is inserted in the microphone jack, namely, the case in which the projector is not used as the loudspeaker.

In this aspect of the invention, in the case in which the operation mode is set either of the first operation mode and the second operation mode, and the input detection device detects that it is the input state (the state in which the user speaks to the external microphone) in which the sound signal is input from the external microphone, the control device sets the state in which the sound output is possible by making the power supply device supply the sound processing device with the electrical power. According to such a configuration, the projector can be set to be in the state in which the sound output is possible without making the user perform an input operation, thus the convenience thereof is further enhanced.

Further, the control device can make the power supply device supply only the signal processing section constituting the sound processing device with the electrical power in the case in which the connection detection device detects that it is in the connection state. Further, the control device can be arranged to make the power supply device supply the amplifying section constituting the sound processing device with the electrical power in the case in which the input detection device detects that it is in the input state.

By adopting the configuration in which the electrical power is supplied to the signal processing section and the amplifying section in a phased manner, since the electrical power is supplied to the amplifying section having higher power consumption compared to the signal processing section only if it is reliably determined that the projector is presently used as the loudspeaker, thereby setting the sound output state, it is possible to provide a projector quick in the rise of the sound compared to the case in which the state of completely halting the electrical power supply to the sound processing device transfers to the state of capable of the sound output, and moreover, having a loudspeaker function with the necessary minimum standby power consumption.

Further, it is also possible that the power supply device includes a sound power supply device adapted to supply the sound processing device with the electrical power, and the cooling device for cooling the sound power supply device can be controlled based on the detection result of the load state of the sound power supply device. According to such a configuration, since the cooling device is driven only when the load of the sound power supply device becomes heavier, namely only when the temperature of the sound power supply device exceeds the predetermined temperature, heat deterioration of the sound power supply device can be prevented while suppressing the noise caused by driving the cooling device in the second operation mode.

Incidentally, if the cooling device is driven and the sound power supply device is cooled, the power supply capacity of the sound power supply device is increased, and thus the sound output capacity of the sound processing device can also be improved, therefore the volume of the sound output from the speaker in an amplified manner can also be increased.

In this aspect of the invention, the volume control section constituting the control device corrects each of the gains (attenuation amount (dB)) of the respective volume values described on the volume table the sound processing device looks up so as to become smaller than the values set previously when, for example, driving of the cooling device is commenced. In other words, by the signal processing section processing the sound signal using the volume table thus corrected, the volume of the sound signal becomes larger compared to the case of using the volume table set previously, namely before the correction, and it is possible to make the volume of the amplified sound output by the speaker larger. Therefore, by increasing the volume itself of the sound amplified and output from the speaker, the influence of the noise while driving the cooling device can be avoided.

In this aspect of the invention, in the case in which a high temperature error (in which the temperature becomes equal to or higher than the service temperature limit (a predetermined threshold value)) occurs in at least either one of the sound processing device and the sound power supply device, the electrical power supply from the power supply device to the sound processing device is halted. Thus, unnecessary power consumption can be avoided while suppressing the heat deterioration of the sound processing device and the sound power supply device.

Further, a projector according to another aspect of the invention includes an image projection device having a light source device and adapted to enlargedly project image light, a control device adapted to control the image projection device, a light source power supply device adapted to supply the light source device with electrical power necessary for an operation of the light source device, a sound processing device having a sound processing section adapted to process a sound signal from an external microphone, and an amplifying section adapted to amplify the sound signal processed by the signal processing section, and a sound power supply device adapted to supply the sound processing device with electrical power necessary for an operation of the sound processing device, wherein the control device includes a power control section adapted to selectively set the projector to be in either one of a normal operation mode in which the light source power supply device is made to supply the light source device with the electrical power, and a standby mode in which the light source power supply is made to halt supplying the electrical power, and the power control section makes the sound power supply device supply the sound processing device with the electrical power in the standby mode, thereby setting the projector to be in a sound output state in which a sound based on the sound signal via the sound processing device can be output.

Here, the projector of this aspect of the invention can be provided with the configuration incorporating the speaker for outputting the sound in an amplified manner based on the sound signal processed by the sound processing device, or it is also possible to adopt the configuration in which an external speaker is additionally connected to the projector, and the sound based on the sound signal processed by the sound processing device is made to be output in an amplified manner via the external speaker.

Further, the power control section is not limited to the configuration of setting the projector to be in the sound output state only in the standby mode, but includes the configuration of setting the projector to be in the sound output state in both of the normal operation mode and the standby mode.

Incidentally, since the light source device does not generate heat in the standby mode in which the light source power supply device is made to halt supplying the light source device with the electrical power, thereby putting off the light source device, the power control section generally performs the control so as to halt driving the cooling fan and so on for cooling the light source device.

In this aspect of the invention, the power control section constituting the control device makes the sound power supply device supply the sound processing device with the electrical power in the standby mode, thereby setting the projector to be in the sound output state in which the sound based on the sound signal via the sound processing device can be output. Thus, when the user amplifies the voice the user produces using the external microphone and the projector, it is prevented that the noise caused by driving the cooling fan or the like is mixed with the voice. Therefore, it is possible to use the projector as a loudspeaker without mixing the noise caused by driving the cooling fan or the like, and thus, the enhancement of the convenience thereof can be achieved.

In the projector according to another aspect of the invention, it is preferable that an operation device adapted to allow input of setting information for setting the projector to be in the sound output state is provided, and the power control section sets the projector to be in the sound output state in response to input of the setting information.

Here, as the operation device, for example, a mechanical switch provided to the projector can also be adopted, besides an operation panel provided to an exterior housing of the projector and a remote controller.

In this aspect of the invention, the power control section sets the projector to be in the sound output state in response to the input of the setting information by the user to the operation device. Thus, it is sufficient for the user to input the setting information only when the user wants to use the projector as the loudspeaker, and thus the enhancement of the convenience thereof can further be achieved.

Further, since the projector is not set to be in the sound output state in the case in which the user does not use the projector as the loudspeaker, namely in the state in which the user does not input the setting information, the electrical power supply from the sound power supply device to the sound processing device can be halted, thus unnecessary power consumption can be avoided.

In the projector according to another aspect of the invention, it is preferable that a microphone jack to which an output plug of the external microphone is inserted, and adapted to output the sound signal from the external microphone to the sound processing section, and a connection detection device adapted to detect a connection state in which the output plug is inserted into the microphone jack, and a non-connection state are provided, and the power control section sets the projector to be in the sound output state in response to detection that it is in the connection state.

Incidentally, in the case in which the user does not use the projector as a loudspeaker, the output plug of the external microphone is not inserted in the microphone jack, in general.

In this aspect of the invention, the power control section sets the projector to be in the sound output state in the case in which the connection detection device detects that it is in the connection state with the output plug of the external microphone inserted in the microphone jack. Thus, whether or not the user uses the projector as the loudspeaker can easily be judged based on the result of the detection by the connection detection device. Therefore, it is possible to set the projector to be in the sound output state without making the user perform the input operation, thus the convenience thereof can further be enhanced.

Further, by adopting the configuration in which, in combination with the input of the setting information to the operation device described above, the power control section sets the projector to be in the sound output state in the case in which the setting information is input and it is detected that it is in the connection state, the following advantage can be obtained.

Specifically, it can be supposed that the user forgets to pull out the output plug of the external microphone from the microphone jack, and the output plug is left inserted therein, even though the user does not use the projector as the loudspeaker. In such a case, if the power control section sets the projector to be in the sound output state on the ground only of the fact that it is in the connection state, it is possible that the sound power supply device supplies the sound processing device with the electrical power even though the user does not use the projector as the loudspeaker, and therefore, the electrical power is consumed unnecessarily.

Therefore, by adopting the configuration in which the power control section sets the projector to be in the sound output state if the setting information is input and at the same time it is detected that it is in the connection state, it can reliably be judged that the projector is used as the loudspeaker, thus the unnecessary power consumption can be avoided.

In the projector according to another aspect of the invention, it is preferable that an input detection device, which is adapted to detect an input state in which the sound signal is input from the external microphone, and a non-input state, is provided, and the power control section sets the projector to be in the sound output state in response to detection that it is in the input state.

Incidentally, there can be supposed the case in which the user does not produce the voice toward the external microphone even in the state in which the output plug of the external microphone is inserted in the microphone jack, namely, the case in which the user does not use the projector as the loudspeaker.

In this aspect of the invention, the power control section sets the projector to be in the sound output state in the case in which the input detection device detects that it is in the input state (the state in which the user produces the voice toward the external microphone) in which the sound signal is input from the external microphone. Thus, whether or not the user presently uses the projector as the loudspeaker can reliably be determined. Therefore, it is possible to set the projector to be in the sound output state without making the user perform the input operation, thus the convenience thereof can further be enhanced.

Further, by adopting the configuration in which, in combination with the detection of the connection state described above, the power control section sets the projector to be in the sound output state in the case in which it is detected that it is in the connection state, and at the same time it is detected that it is in the input state, the following advantage can be obtained.

For example, the power control section makes the sound power supply device supply the electrical power only to the signal processing section in the case in which it is detected that it is in the connection state. Further, if it is detected that it is in the input state, the power control section makes the sound power supply device supply the electrical power also to the amplifying section.

As described above, since the projector can be set to be in the sound output state by supplying the electrical power to the amplifying section having higher power consumption compared to the signal processing section only if it is reliably determined that the user presently uses the projector as the loudspeaker by adopting the configuration in which the electrical power is made to be supplied to the signal processing section and the amplifying section in a phased manner, lower power consumption can be achieved.

In the projector according to another aspect of the invention, it is preferable that the power control section makes the electrical power supply at least to the amplifying section in the sound processing device be halted in the case in which it is detected that it is in the non-input state after once setting the projector to be in the sound output state.

In this aspect of the invention, the power control section makes the electrical power supply at least to the amplifying section in the sound processing device be halted in the case described above. Thus, since the power supply at least to the amplifying section having higher power consumption is halted if the user uses the projector as the loudspeaker and then stops using it, unnecessary power consumption can be avoided.

In the projector according to another aspect of the invention, it is preferable that a load detection device adapted to detect a load state of the sound power supply device, and a cooling device adapted to cool the sound power supply device are provided, and the control device includes a cooling control section adapted to control the cooling device based on the load state.

In this aspect of the invention, the cooling control section constituting the control device drives the cooling device to cool the sound power supply device if, for example, it is detected by the load detection device that the load of the sound power supply device becomes heavier. Thus, since the cooling device is driven only if the load of the sound power supply device becomes heavier, namely only if the temperature of the sound power supply device exceeds the predetermined temperature, heat deterioration of the sound power supply device can be prevented while suppressing the noise caused by driving the cooling device in the standby mode.

In the projector according to another aspect of the invention, it is preferable that the signal processing section processes the sound signal with a gain corresponding to a volume value set previously, and the control device includes a volume control section adapted to vary the gain in accordance with an operation state of the cooling device.

Incidentally, if the cooling device is driven and the sound power supply device is cooled, the power supply capacity of the sound power supply device is increased, and thus the sound output capacity of the sound processing device can also be improved, the sound output from the speaker in an amplified manner can also be increased.

In this aspect of the invention, the volume control section constituting the control device corrects each of the gains (attenuation amount (dB)) of the respective volume values on the volume table used by the signal processing section so as to become smaller than the values set previously in response, for example, to commencement of driving of the cooling device. In other words, by the signal processing section processing the sound signal using the volume table thus corrected, the volume of the sound signal becomes larger compared to the case of using the volume table set previously, namely before the correction, and it is possible to make the volume of the amplified sound output by the speaker larger. Therefore, by increasing the volume itself of the sound amplified and output from the speaker, the influence of the noise while driving the cooling device can be avoided.

In the projector according to another aspect of the invention, it is preferable that there is provided a temperature detection device adapted to detect temperature of at least either one of the sound processing device and the sound power supply device, and the power control section makes the sound power supply device halt supplying the electrical power at least to the amplifying section in the case in which the temperature is equal to or higher than a predetermined threshold value after once setting the projector to be in the sound output state.

In this aspect of the invention, in the case in which a high temperature error (in which the temperature becomes equal to or higher than the service temperature limit (the predetermined threshold value)) occurs in at least either one of the sound processing device and the sound power supply device after once setting the projector to be in the sound output state, the power control section makes the sound power supply device halt supplying the electrical power at least to the amplifying section. Thus, it is possible to avoid unnecessary power consumption by halting the electrical power supply at least to the amplifying section having higher power consumption, while suppressing the heat deterioration of the sound processing device and the sound power supply device.

In the projector according to another aspect of the invention, it is preferable that there is provided a cooling device adapted to cool at least either one of the sound processing device and the sound power supply device, the control device includes a cooling control section adapted to make the cooling device operate in a case in which the temperature is one of equal to and higher than the predetermined threshold value, and the power control section sets the projector to be in the sound output state once again when the temperature becomes lower than the predetermined threshold value after making the sound power supply device halt supplying the electrical power at least to the amplifying section after once setting the projector to be in the sound output state.

In this aspect of the invention, in the case in which the high temperature error occurs in at least either one of the sound processing device and the sound power supply device, and the sound power supply device is made to halt supplying the electrical power at least to the amplifying section, and then the sound processing device or the sound power supply device is recovered from the high temperature error to be in the normal state (with the temperature lower than the service temperature limit) due to the control of the cooling device by the cooling control section, the power control section sets the projector to be in the sound output state once again. In other words, in the high temperature error, the energy thereof is concentrated on the cooling by the cooling device, and after recovering from the high temperature error to the normal state, the projector can be used as the loudspeaker once again. Therefore, it is possible to quickly put the projector into the state in which the projector can be used as the loudspeaker while effectively suppressing the heat deterioration of the sound processing device and the sound power supply device.

A control method according to another aspect of the invention includes providing, to a projector, an image projection device having a light source device and adapted to enlargedly project image light, a control device adapted to control the image projection device, a light source power supply device adapted to supply the light source device with electrical power necessary for an operation of the light source device, a sound processing device adapted to process a sound signal from an external microphone, and a sound power supply device adapted to supply the sound processing device with electrical power necessary for an operation of the sound processing device, and making, by the control device, the sound power supply device supply the sound processing device with the electrical power in the standby mode in which the light source power supply device is made to halt supplying the electrical power, thereby setting the projector to be in a sound output state in which a sound based on the sound signal via the sound processing device can be output.

Since the control method according to this aspect of the invention is executed using the projector described above, substantially the same functions and the advantages as in the projector described above can be obtained.

### BRIEF DESCRIPTION OF THE DRAWINGS

The invention will be described with reference to the accompanying drawings, wherein like numbers reference like elements.

FIG. 1 is a block diagram showing a schematic configuration of a projector according to the present embodiment.

FIG. 2 is a circuit diagram showing a configuration of a microphone jack and a connection detection device according to the embodiment.

FIG. 3 is a flowchart for explaining a control method according to the embodiment.

FIG. 4 is a flowchart for explaining the control method according to the embodiment.

FIG. 5 is a flowchart for explaining the control method according to the embodiment.

FIG. 6 is a flowchart for explaining the control method according to the embodiment.

FIG. 7 is a flowchart for explaining the control method according to the embodiment.

FIG. 8 is a diagram showing a modified example of the embodiment.

FIGS. 9A through 9C are diagrams showing modified examples of the embodiment.

### DESCRIPTION OF EXEMPLARY EMBODIMENTS

An embodiment of the invention will hereinafter be explained with reference to the accompanying drawings.

### Configuration of Projector

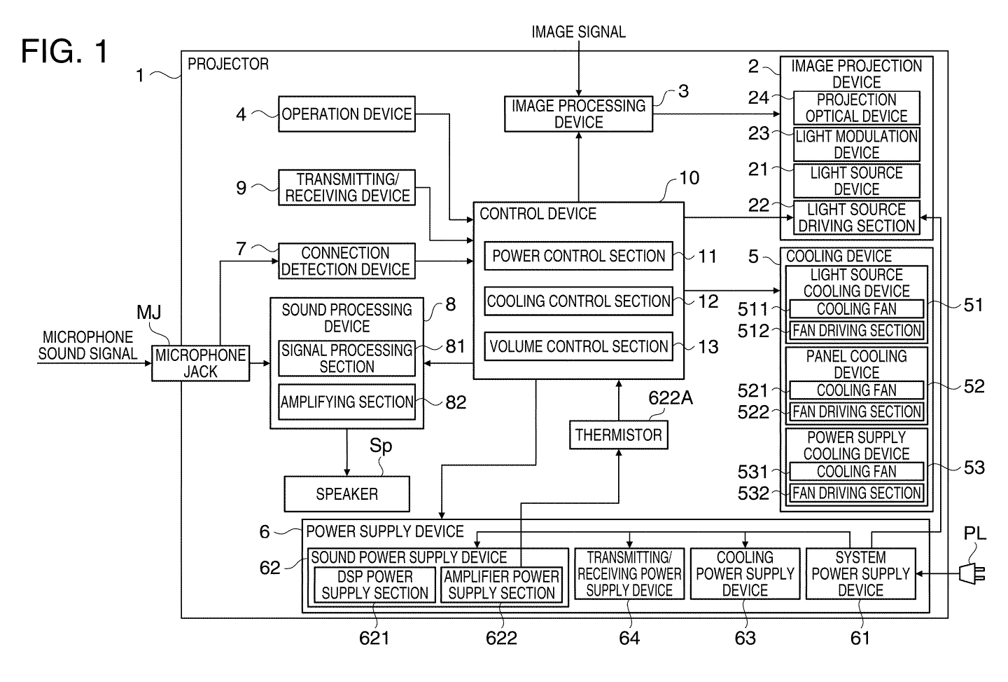

FIG. 1 is a block diagram showing a schematic configuration of the projector 1.

The projector 1 is for forming image light by modulating an optical beam emitted from the light source in accordance with image information, and enlargedly projecting the image light thus formed on a screen (not shown). As shown in FIG. 1, the projector 1 is mainly composed of an image projection device 2, an image processing device 3, an operation device 4, a plurality of cooling devices 5, a power supply device 6, a connection detection device 7, a sound processing device 8, a transmitting/receiving device 9, and a control device 10.

The image projection device 2 forms the image light, and then enlargedly projects the image light. As shown in FIG. 1, the image projection device 2 is provided with a light source device 21, a light source driving section 22 as a power supply device for the light source, a light modulation device 23, and a projection optical device 24.

The light source device 21 emits a light beam towards the light modulation device 23. In the present embodiment, the light source device 21 is formed of a discharge emission light source lamp.

The light source driving section 22 inputs the power supplied from a system power supply device 61 described above, and under the control by the control device 10, converts the power into the power necessary for an operation of the light source device 21 to supply the light source device 21 with the power, thereby lighting the light source device 21.

The light modulation device 23 is formed of a liquid crystal panel, and modulates the light beam emitted from the light source device 21 into the image light, and emits the image light toward the projection optical device 24.

The projection optical device 24 enlargedly projects the image light emitted from the light modulation device 23.

In accordance with a control command from the control device 10, the image processing device 3 executes predetermined image processing on the image signal thus input, outputs the drive signal based on the image signal, on which the image processing is executed, to the light modulation device 23, thereby making the light modulation device 23 form predetermined image light.

The operation device 4 is composed of a remote controller not shown, and an operation panel provided to an exterior housing of the projector 1 so as to be exposed therefrom, and recognizes an operation by the user to output a predetermined operation signal to the control device 10.

It should be noted that although not shown specifically, as buttons and keys of the remote controller and the operation panel, there can be exemplified a power button for performing power-ON/OFF of the projector 1, a menu button for displaying a menu screen, a selection key for allowing selection of an item on the menu screen, a volume control key for controlling the volume of the sound amplified and output from a speaker Sp (FIG. 1), and so on.

The cooling devices 5 are provided corresponding to cooling objects inside the projector 1, and respectively cool the cooling objects.

In the present embodiment, the cooling devices 5 are composed of three cooling devices 51 through 53, as shown in FIG. 1.

The light source cooling device 51 is for cooling the light source device 21, and provided with a cooling fan 511, and a fan driving section 512 for driving the cooling fan 511 with a drive voltage corresponding to the control command by the control device 10 based on the power supplied from the power supply device 6.

The panel cooling device 52 is for cooling the light modulation device 23, and provided with a cooling fan 521 and a fan driving section 522 similarly to the light source cooling device 51.

The power supply cooling device 53 is for cooling the light source driving section 22 and the power supply device 6, and provided with a cooling fan 531 and a fan driving section 532 similarly to the cooling devices 51, 52.

The power supply device 6 supplies each constituent of the projector 1 with electrical power. As shown in FIG. 1, the power supply device 6 is mainly provided with a system power supply device 61, a sound power supply device 62, a cooling power supply device 63, and a transmitting/receiving power supply device 64.

The system power supply device 61, to which the commercial alternating-current power is input via a power plug PL (FIG. 1), supplies the sound power supply device 62, the cooling power supply device 63, and the transmitting/receiving power supply device 64 with the commercial alternating-current power, and further supplies the control device 10 and the light source driving section 22 with the power necessary for the respective operations.

The sound power supply device 62 converts the electrical power supplied from the system power supply device 61 into the electrical power necessary for the operation of the sound processing device 8, and then supplies the sound processing device 8 with the electrical power thus converted. As shown in FIG. 1, the sound power supply device 62 is provided with a DSP power supply section 621 for converting the electrical power into the electrical power necessary for an operation of a signal processing section 81, described later, of the sound processing device 8 and supplying it to the signal processing section 81, and an amplifier power supply section 622 for converting the electrical power into the electrical power necessary for an operation of an amplifying section 82, described later, of the sound processing device 8 and supplying it to the amplifying section 82.

The cooling power supply device 63 converts the electrical power supplied from the system power supply device 61 into the electrical power necessary for the operations of the cooling fans 511 through 531, and then supplies the cooling devices 5 with the electrical power thus converted, respectively.

The transmitting/receiving power supply device 64 converts the electrical power supplied from the system power supply device 61 into the electrical power necessary for the operation of the transmitting/receiving device 9, and then supplies the transmitting/receiving device 9 with the electrical power thus converted.

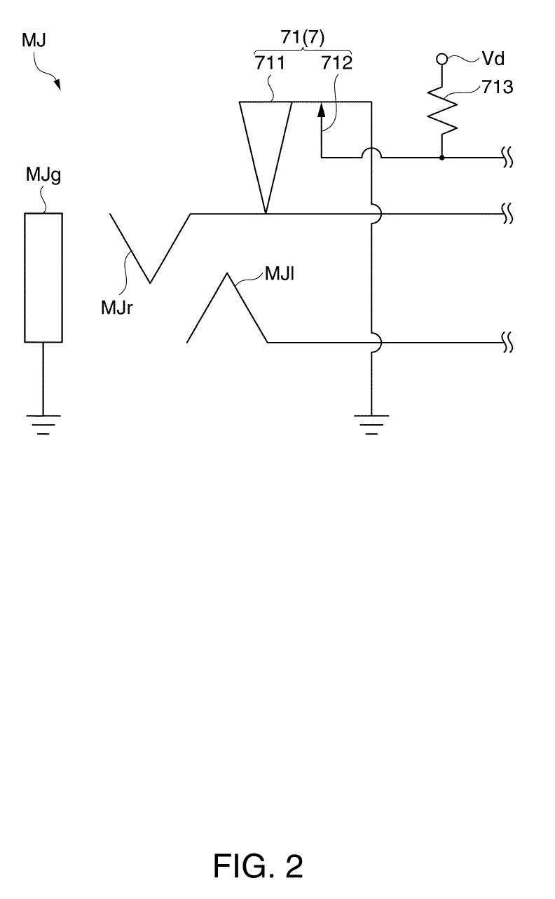

FIG. 2 is a circuit diagram showing a configuration of a microphone jack MJ and a connection detection device 7.

It should be noted that FIG. 2 shows the microphone jack MJ in the case in which an output plug (not shown) of the external microphone is a three prong stereo plug, for the sake of convenience of explanations.

As shown in FIG. 2, the microphone jack MJ is provided with a GND contact MJg, an R channel contact MJr, and an L channel contact MJl to be electrically connected respectively to a GND contact, an R channel contact, and an L channel contact of the output plug of the external microphone.

Further, in the state in which the output plug of the external microphone is inserted into the microphone jack MJ, an R channel signal (a sound signal) and an L channel signal (a sound signal) output from the external microphone is input via the R channel contact MJr and the L channel contact MJl, and then output to the sound processing device 8 not shown in FIG. 2.

As shown in FIG. 2, the connection detection device 7 has a so-called switch 71 provided with a first switch section 711 connected to the GND potential level and having contact with the R channel contact MJr, and a second switch section 712 forming a contact state when having contact with the first switch section 711 or a non-contact state when being separated therefrom.

In other words, the potential of the second switch section 712 becomes the GND potential in the non-connection state in which the output plug of the external microphone is not inserted in the microphone jack MJ, since the first and second switch sections 711, 712 are in the contact state. On the other hand, in the connection state in which the output plug of the external microphone is inserted in the microphone jack MJ, since the first switch section 711 is pushed up by the R channel contact MJr, and the first and second switch sections 711, 712 become in the non-contact state, the potential of the second switch section 712 varies in accordance with a pull-up resistor 713 connected to the second switch section 712 and a direct-current power supply Vd.

Therefore, the connection detection device 7 detects the variation in the potential described above, thereby detecting the connection state and the non-connection state described above. Then, the connection detection device 7 outputs the detection result to the control device 10.

The sound processing device 8 processes the sound signal (hereinafter referred to as microphone sound signal) input via the microphone jack MJ, and makes the speaker Sp amplify and output the sound corresponding to the sound signal. As shown in FIG. 1, the sound processing device 8 is provided with the signal processing section 81 and the amplifying section 82.

The signal processing section 81 is formed of a digital signal processor (DSP), and processes the microphone sound signal in accordance with a tone quality set and the volume set by an operation of the user to the operation device 4.

For example, the signal processing section 81 controls the volume using such a volume table as described below.

Specifically, the volume table has values of a gain (an attenuation value (dB) increasing, e.g., as volume value varies from 10 toward 0) set in accordance with the respective volume values (e.g., 11 levels of 0 through 10) set in accordance with the operation by the user to the operation device 4.

Then, the signal processing section 81 recognizes the gain value corresponding to the volume value set in accordance with the operation by the user to the operation device 4 based on the volume table, and then processes the microphone sound signal with the gain value thus recognized.

Further, the signal processing section 81 detects the signal level (e.g., an effective value or a peak value) of the microphone sound signal, thereby detecting whether it is in an input state in which the microphone sound signal is input or it is in a non-input state in which the signal level is lower than a predetermined level continuously for a predetermined period of time. In other words, the signal processing section 81 corresponds to an input detection device according to the embodiment of the invention.

The amplifying section 82 is a so-called an amplifier, and amplifies the sound signal, which has been processed by the signal processing section 81, with a predetermined gain, and then outputs it to the speaker Sp, thereby making the speaker Sp output the amplified sound corresponding to the microphone sound signal.

The transmitting/receiving device 9 is mainly composed of a network interface such as a local are network (LAN), a parallel interface, and a serial interface, and has a function of communicating information with an external device. For example, the transmitting/receiving device 9 receives a control command from an external PC (not shown) or the like, converts the control command thus received into the information corresponding to an interface standard, and then outputs the information to the control device 10. Further, the transmitting/receiving device 9 converts the information output from the control device 10 into the information corresponding to the interface standard, and then transmits the information to the external PC or the like described above.

The control device 10 is mainly composed of a central processing unit (CPU), and controls the overall projector 1 along a control program stored in a memory device not shown. It should be noted that hereinafter control structures for the cooling devices 5, the power supply devices 6, and the sound processing device 8 will mainly be explained as the constituents of the control device 10, and explanations of control structures for other devices such as the image processing device 3 will be omitted. As shown in FIG. 1, the control device 10 is provided with a power control section 11, a cooling control section 12, and a volume control section 13.

The power control section 11 outputs a control command to the light source driving section 22 and the power supply devices 6 in accordance with the information stored in a memory device not shown and an input operation by the user to the operation device 4, and makes the projector 1 transfer to a normal operation mode, namely a first operation mode in the invention, or a standby mode.

In the present embodiment, as the standby mode there are provided three modes, namely a microphone standby mode (corresponding to a second operation mode in the invention, hereinafter referred to as a MicSTB mode), a basic standby mode (corresponding to a third operation mode in the present invention, hereinafter referred to as a basic STB mode), and a network standby mode (hereinafter referred to as NWSTB mode). The NWSTB mode can be called a fourth operation mode.

Specifically, the normal operation mode is a mode for supplying the electrical power from the light source driving section 22 and the power supply devices 6 to the corresponding constituents in order for making all of the constituents of the projector 1 operable.

The MicSTB mode is a mode for supplying the control device 10 and the transmitting/receiving device 9 with the electrical power, and at the same time setting the projector 1 to be in the state in which the electrical power can be supplied from the sound power supply device 62 to the sound processing device 8. In other words, the MicSTB mode is a mode in which the control device 10 and the transmitting/receiving device 9 operates, and at the same time the sound processing device 8 is operable.

The basic STB mode is a mode for supplying the electrical power from the system power supply device 61 only to the control device 10. In other words, the basic STB mode is a mode in which only the control device 10 operates.

The NWSTB mode is a mode for supplying the electrical power from the system power supply device 61 to the control device 10, and at the same time, supplying the electrical power from the transmitting/receiving power supply device 64 to the transmitting/receiving device 9. In other words, the NWSTB mode is a mode in which only the transmitting/receiving device 9 operates besides the control device 10.

For example, the control device 10 can make the user select either one of a state in which the NWSTB mode is “valid” and a state in which the NWSTB mode is “invalid” in the condition of displaying the menu screen by the input operation of the operation device 4. Further, the control device 10 stores the information, which represents that the basic STB mode is set, in the memory device not shown when the NWSTB mode is selected to be “invalid.”

On the other hand, the control device 10 can further make the user select either one of a state in which the MicSTB mode is “valid” and a state in which the MicSTB mode is “invalid” on the menu screen when the NWSTB mode is selected to be “valid.” Further, the control device 10 stores the information, which represents that the NWSTB mode is set, in the memory device not shown when the MicSTB mode is selected to be “invalid.” Further, the control device 10 stores the information, which represents that the MicSTB mode is set, in the memory device not shown when the MicSTB mode is selected to be “valid” (input of the setting information according to the invention).

Then, the power control section 11 checks the information described above stored in the memory not shown when the power plug PL is inserted into the socket and the electrical power is supplied from the system power supply device 61 to the control device 10, and sets either one of the basic STB mode, the NWSTB mode, and the MicSTB mode.

Further, the power control section 11 makes the projector 1 to the normal operation mode if the power button is held down (the projector 1 is powered ON) by the operation of the user to the operation device 4 in either one of the three standby modes.

On the other hand, the power control section 11 checks the information described above stored in the memory device not shown and makes the projector 1 to either one of the basic STB mode, the NWSTB mode, and the MicSTB mode similarly to the above if the power button is held down (the projector 1 is powered OFF) by the operation of the user to the operation device 4 in the normal operation mode.

Further, in the MicSTB mode, the power control section 11 starts or stops the power supply from the sound power supply device 62 to the sound processing device 8 in accordance with the signal from the signal processing section 81 and the signal from a thermistor 622A (FIG. 1) as a temperature detection device for detecting the temperature of the amplifier power supply section 622.

The cooling control section 12 outputs a control command to each of the fan driving sections 512 through 532 in the cooling devices 5 to control the respective fan driving sections 512 through 532.

The volume control section 13 varies the gain on the volume table, which is used by the signal processing section 81, in accordance with the operation state of the power supply cooling device 53.

### Control Method of Projector

Then, the control method of the projector 1 described above will hereinafter be explained with reference to the drawings.

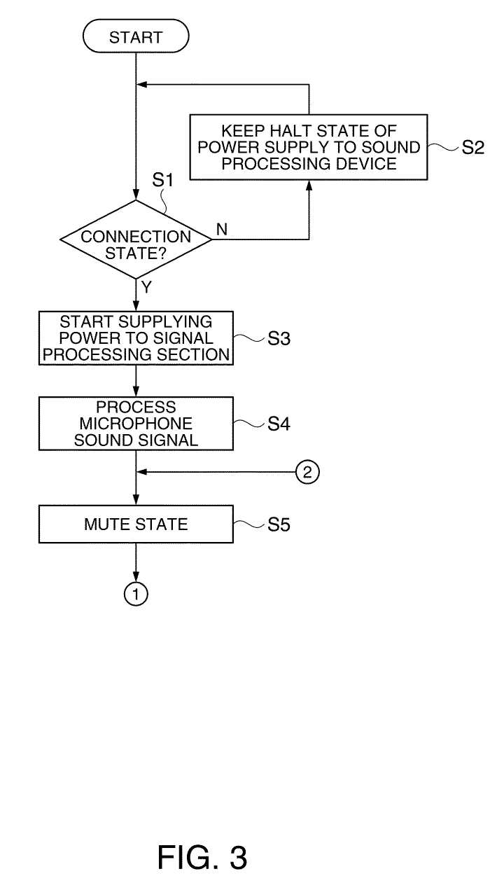

FIGS. 3 through 7 are flowcharts for explaining the control method.

It should be noted that hereinafter it is assumed that the power control section 11 sets the projector 1 in the MicSTB mode in accordance with the input (for setting the NWSTB mode to be “valid” and the MicSTB mode to be “valid”) described above by the user to the operation device 4.

Further, hereinafter, the explanations are presented separately into the process (hereinafter referred to as a pre-output process) before the sound based on the microphone sound signal is amplified and output from the speaker Sp and the process (hereinafter referred to as a post-output process) after the sound based on the microphone sound signal is amplified and output from the speaker Sp as the control method of the projector 1 for the sake of convenience of explanations.

### Pre-Output Process

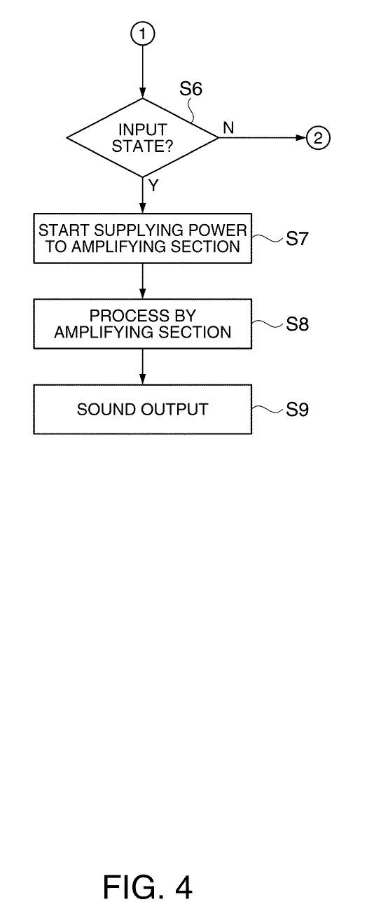

Firstly, the pre-output process will be explained with reference to FIGS. 3 and 4. Here, it is assumed that the operation mode is set to be a mode in which the sound output is allowed, namely the normal mode (the first operation mode) or the MicSTB mode (the second operation mode).

The power control section 11 determines whether or not the connection detection section 7 detects that the external microphone is in the connection state (step S1).

If the power control section 11 determines in the step S1 that it is “N” (in the case of the non-connection state), the power control section 11 keeps the halt state of the power supply from the sound power supply device 62 to the sound processing section 8 (step S2).

Further, in the step S1, if the power control section 11 determines that it is “Y” (in the case of the connection state), the power control section 11 outputs a control command to the DSP power supply section 621 out of the DSP power supply section 621 and the amplifier power supply section 622 to make the DSP power supply section 621 supply the signal processing section 81 with the electrical power (step S3: the power control step).

After the step S3, the control device 10 outputs a control command to the sound processing device 8 (the signal processing section 81) to make the sound processing device 8 process the microphone sound signal (step S4).

After the step 4, since the control device 10 is in the state in which the control device 10 does not make the amplifier power supply section 622 supply the amplifying section 82 with the electrical power as described above, the control device 10 becomes in a mute state in which the control device 10 does not make the speaker Sp output the sound based on the microphone sound signal in an amplified manner even if the microphone sound signal is input thereto (step S5).

After the step S5, the power control section 11 determines whether or not the signal processing section 81 detects that it is the input state (step S6).

In the step S6, if the power control section 11 determines that it is “N” (in the case of the non-input state), the power control section 11 keeps the halt state of the power supply from the amplifier power supply section 622, and continues the mute state.

On the other hand, if the power control section 11 determines in the step S6 that it is “Y” (in the case of the input state), the power control section 11 makes the amplifier power supply section 622 supply the amplifying section 82 with the electrical power (step S7: the power control step).

In other words, according to the step S7, since the control device 10 is set in the state (the sound output state) in which the control device 10 makes both of the DSP power supply section 621 and the amplifier power supply section 622 respectively supply the signal processing section 81 and the amplifying section 82 with the electrical power, the control device 10 is led to release the mute state described above.

After the step S7, the control device 10 outputs a control command to the signal processing section 81 and the amplifying section 82 to make the amplifying section 82 amplify the sound signal processed by the signal processing section 81 (step S8) in parallel to the process of the step S4 described above.

Then, after the step S8, the sound based on the sound signal thus processed by the sound processing device 8 is output from the speaker Sp in an amplified manner (step S9).

### Post-Output Process

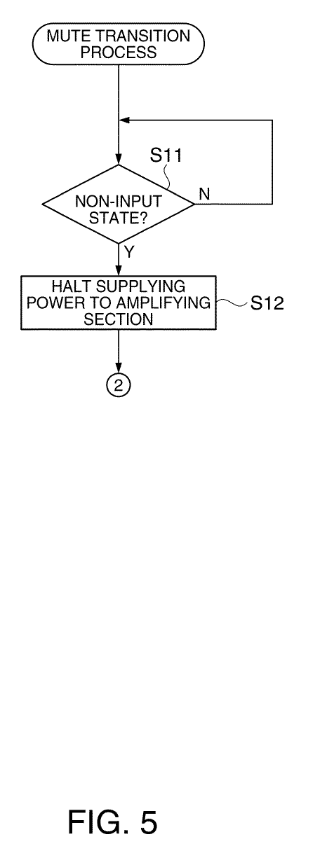

Then, the post-output process will hereinafter be explained with reference to FIGS. 5 through 7.

It should be noted that hereinafter the explanations will be presented separately into a process (hereinafter referred to as a mute transition process) of transition to the mute state in response to the detection of the non-input state by the signal processing section 81, a process (hereinafter referred to as a cooling/volume process) by the cooling control section 12 and the volume control section 13, and a process (hereinafter referred to as an error process) by the power control section 11 in the case in which a temperature error of the amplifier power supply section 622 occurs, as the post-output process for the sake of convenience of the explanations.

### Mute Transition Process

Firstly, the mute transition process will be explained with reference to FIG. 5.

After the step S9, the control device 10 continues to determine the result of detection by the signal processing section 81, and determines whether or not the result of detection by the signal processing section 81 becomes the non-input state (step S11).

In the step S11, if the control device 10 determines that it is “N” (in the case in which the input state continues), the control device 10 makes the speaker Sp continue to output the amplified sound (steps S4, S8, and S9).

On the other hand, if the power control section 11 determines in the step S11 that it is “Y” (in the case in which the state has changed to the non-input state), the power control section 11 stops the power supply from the amplifier power supply section 622 (step S12), and makes transition to the mute state in the step S5.

### Cooling/Volume Process

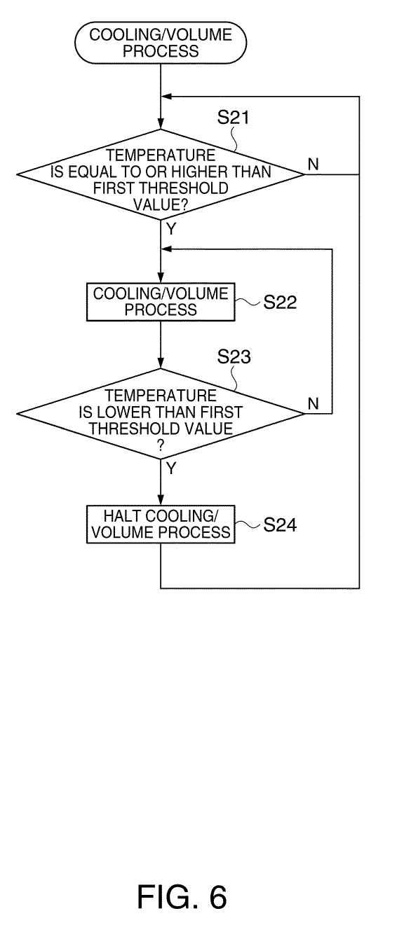

Then, the cooling/volume process will be explained with reference to FIG. 6.

After the step S9, the control device 10 recognizes the temperature of the amplifier power supply section 622 based on the signal from the thermistor 622A, and constantly monitors whether or not the temperature of the amplifier power supply section 622 becomes equal to or higher than a predetermined first threshold value (step S21).

In the step S21, if the control device 10 determines that it is “Y” (in the case in which the temperature is equal to or higher than the first threshold value), namely if the control device 10 determines that the load of the amplifier power supply section 622 becomes heavy, the control device 10 executes the cooling/volume process described below (step S22).

In other words, the thermistor 622A also functions as a load detection device besides the temperature detection device according to the invention.

The cooling control section 12 outputs the control command only to the fan driving section 532, thereby making it drive only the power supply cooling device 53 among the cooling devices 51 through 53. In other words, the cooling control section 12 makes the power supply device 6 (the amplifier power supply section 622) to be cooled.

Further, in response to the commencement of the drive of the power supply cooling device 53 described above, the volume control section 13 corrects the volume table used by the signal processing section 81 so that the values of the gain corresponding to the respective volume values becomes larger than the values set previously. By the signal processing section 81 processing the microphone sound signal using the volume table thus corrected, the volume of the microphone sound signal becomes larger compared to the case of using the volume table set previously, namely before the correction, and the volume of the amplified sound output by the speaker Sp becomes larger. Further, since the temperature rise in the amplifying section 82 and the power supply device 6 (the amplifier power supply section 622) can be suppressed by the power supply cooling device 53 operating, it becomes possible to perform driving with a load heavier than in the case in which the power supply cooling device 53 does not operate, thus the volume value larger than before the correction can be set.

After the step S22, the control device 10 constantly monitors the temperature of the amplifier power supply section 622 based on the signal from the thermistor 622A, and determines whether or not the temperature of the amplifier power supply section 622 becomes lower than the predetermined first threshold value (step S23).

In the step S23, if the control device 10 determines that it is “N” (in the case in which the temperature is equal to or higher than the first threshold value), the control device 10 continues the cooling/volume process of the step S22.

On the other hand, in the step S23, if the control device 10 determines that it is “Y” (in the case in which the temperature is lower than the first threshold value), the control device 10 halts the cooling/volume process of the step S22 (step S24), and then transfers to the process of the step S21 for executing the process again.

In other words, in the step S24, the cooling control section 12 halts the driving of the power supply cooling device 53, thereby halting the cooling of the power supply device 6 (the amplifier power supply section 622).

Further, in response to the halt of the drive of the power supply cooling device 53 described above, the volume control section 13 retrieves the values of the gain corresponding to the respective volume values to the values set previously in the volume table used by the signal processing section 81.

### Error Process

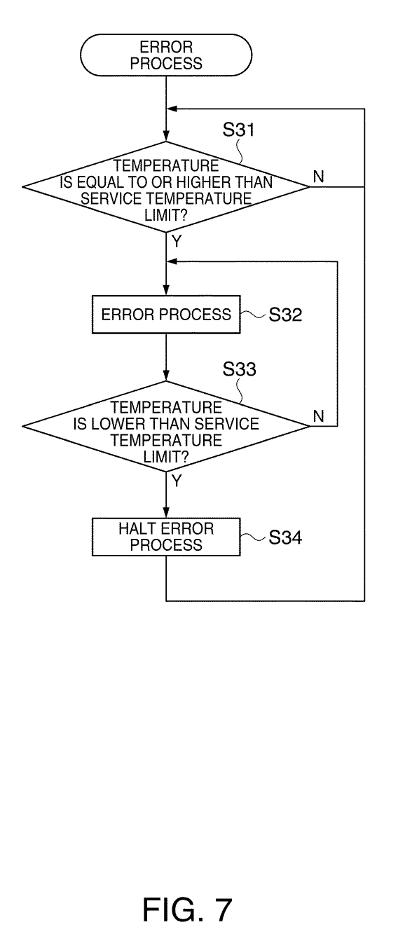

Then, the error process will be explained with reference to FIG. 7.

It should be noted that since the error process is a process substantially the same as the cooling/volume process described above, the different point therebetween will hereinafter be explained.

Specifically, the steps S31 and S33 in the error process are substantially the same as the steps S21 and S23 described above, respectively, and are different therefrom in that the service temperature limit of the amplifier power supply section 622 is used as the comparative object of the temperature of the amplifier power supply section 622 instead of the first threshold value.

Here, the service temperature limit is higher than the first threshold value.

Further, the steps S32 and S34 in the error process are substantially the same as the steps S22 and S24 described above, and are different therefrom in that the error process is executed or halted instead of the cooling/volume process.

Specifically, in the step S32, when the temperature of the amplifier power supply section 622 becomes equal to or higher than the service temperature limit, the power control section 11 halts the power supply from the amplifier power supply section 622. Specifically, the mute state described above is set in the step S32.

It should be noted that, as described above, since the service temperature limit is higher than the first threshold value, when the temperature of the amplifier power supply section 622 becomes equal to or higher than the service temperature limit, the power supply cooling device 53 is driven in the step S22 described above, and thus the power supply device 6 (the amplifier power supply section 622) is cooled.

Then, in the step S34, when the temperature of the amplifier power supply section 622 becomes lower than the service temperature limit due to the cooling of the power supply device 6, the power control section 11 restarts the power supply from the amplifier power supply section 622.

According to the present embodiment described above, the following advantages are obtained.

In the present embodiment, the power control section 11 constituting the control device 10 makes the sound power supply device 62 supply the sound processing device 8 with the electrical power in the MicSTB mode, and sets the sound output state in which the sound based on the sound signal via the sound processing device 8 can be output from the speaker Sp. Thus, when the user amplifies the voice the user produces using the microphone and the projector 1, the noise caused by driving the cooling device 5 can be prevented from being mixed with the voice. Therefore, it is possible to use the projector 1 as a loudspeaker without mixing the noise caused by driving the cooling device 5, and thus, the enhancement of convenience can be achieved.

Further, in the case in which the NWSTB mode is selected to be “valid” and the MicSTB mode is also selected to be “valid” by the operation of the operation device 4 by the user, the power control section 11 sets the sound output state. Thus, it is sufficient for the user to perform the selection described above only when the user wants to use the projector 1 as the loudspeaker, and thus the enhancement of convenience can further be achieved.

Further, in the case in which the user does not use the projector 1 as the loudspeaker, namely in the state in which the user does not perform the selection described above, the projector 1 is set to be in the basic STB mode or the NWSTB mode, namely the projector 1 is not set to be in the sound output state, and therefore, the power supply from the sound power supply device 62 to the sound processing device 8 can be halted, thus unnecessary power consumption can be avoided.

Further, in the case in which the connection detection device 7 detects that it is in the connection state, the power control section 11 sets the projector 1 to be in the sound output state. Thus, whether or not the user uses the projector 1 as the loudspeaker can easily be judged based on the result of the detection by the connection detection device 7.

Further, in the case in which the user performs the selection described above and it is detected to be in the connection state, the power control section 11 sets the projector 1 to be in the sound output state. Thus, even if the user forgets to pull out the output plug of the external microphone from the microphone jack MJ although not using the projector 1 as the loudspeaker, and the output plug is left inserted therein, it is not set to be in the sound output state unless the user performs the selection described above, and therefore, unnecessary power consumption can be avoided.

Further, in the case in which the signal processing section 81 detects that it is in the input state, the power control section 11 sets the projector 1 to be in the sound output state. Thus, whether or not the user presently uses the projector 1 as the loudspeaker can reliably be determined.

Further, in the case in which the user performs the selection described above, and it is detected to be in the connection state, the power control section 11 makes the DSP power supply section 621 supply the electrical power only to the signal processing section 81. Further, in the case in which it is detected to be in the input state, the power control section 11 makes the amplifier power supply section 622 supply the electrical power also to the amplifying section 82. Thus, since it is configured to supply the signal processing section 81 and the amplifying section 82 with the electrical power in a phased manner, and the projector 1 is set to be in the sound output state by supplying the electrical power to the amplifying section 82 having higher power consumption compared to the signal processing section 81 only if it is reliably determined that the user presently uses the projector 1 as the loudspeaker, lower power consumption can be achieved.

Further, in the case in which the signal processing section 81 detects that it is in the non-input state after it has once been set to be in the sound output state, the power control section 11 halts the power supply to the amplifying section 82. Thus, since the power supply to the amplifying section 82 having higher power consumption is halted in the case in which the user uses the projector 1 as the loudspeaker and then stops using it, unnecessary power consumption can be avoided.

Further, in the case in which the cooling control section 12 constituting the control device 10 recognizes that the load of the amplifier power supply section 622 becomes heavier based on the signal from the thermistor 622A, the cooling control section 12 drives the power supply cooling device 53 to cool the power supply device 6 (the amplifier power supply section 622). Thus, since the cooling control section 12 drives only the power supply cooling device 53 only when the load of the amplifier power supply section 622 becomes heavier, namely only when the temperature of the amplifier power supply section 622 becomes equal to or higher than the predetermined temperature (the first threshold value), it is possible to prevent heat deterioration of the power supply device 6 (the amplifier power supply section 622) while suppressing the noise caused by driving the cooling device 5 in the MicSTB mode.

Further, the volume control section 13 constituting the control device 10 corrects the volume table used by the signal processing section 81 in response to the commencement of driving of the power supply cooling device 53 so that the volume of the sound amplified and output from the speaker Sp becomes larger compared to the case of using the volume table set previously, namely before the correction. Thus, by increasing the volume itself of the sound amplified and output from the speaker Sp, the influence of the noise while driving the power supply cooling device 53 can be avoided. Further, since the temperature rise in the amplifying section 82 and the power supply device 6 (the amplifier power supply section 622) can be suppressed by the power supply cooling device 53 operating, it becomes possible to perform driving with a load heavier than in the case in which the power supply cooling device 53 does not operate, thus the volume value larger than before the correction can be set.

Further, in the case in which a high temperature error (in which the temperature exceeds the service temperature limit) is caused in the amplifier power supply section 622 after it has once been set to be in the sound output state, the power control section 11 halts the power supply to the amplifying section 82. Thus, it is possible to avoid unnecessary power consumption by halting the electrical power supply to the amplifying section 82 having higher power consumption, while suppressing the heat deterioration of the amplifier power supply section 622. Further, protection (security) of the circuit becomes possible.

Further, in the case in which the power supply to the amplifying section 82 is halted due to the high temperature error caused in the amplifier power supply section 622, and then the power supply device 6 (the amplifier power supply section 622) recovers from the high temperature error to the normal state (in which the temperature is lower than the service temperature limit) due to the cooling control section 12 driving the power supply cooling device 53, the power control section 11 restarts the power supply to the amplifying section 82. In other words, in the high temperature error, the energy thereof is concentrated on the cooling by the power supply cooling device 53, and after recovering from the high temperature error to the normal state, the projector 1 can be used as the loudspeaker once again. Therefore, it is possible to quickly put the projector 1 into the state in which the projector 1 can be used as the loudspeaker while effectively suppressing the heat deterioration of the amplifier power supply section 622.

It should be noted that the invention is not limited to the embodiment described above but includes modifications and improvements in a range where the advantages of the invention can be achieved.

Although in the embodiment described above, the projector 1 incorporates the speaker Sp, this is not the limitation, but it is also possible to adopt a configuration in which an external speaker is additionally connected to the projector, and the sound based on the sound signal processed by the sound processing device 8 is amplified and output via the external speaker.

Although in the embodiment described above, the configuration in which the projector 1 can be used as the loudspeaker in the MicSTB mode is mainly explained, since the power supply devices 6 supplies the respective constituents with the electrical power also in the normal operation mode, the projector 1 can be used as the loudspeaker in the normal operation mode.

Although in the embodiment described above, there is adopted the configuration of selecting the input of the setting information according to the invention on the menu screen, this is not the limitation, but it is also possible to adopt the configuration in which, for example, a mechanical switch (an operation device) is provided so as to be exposed from the exterior housing of the projector 1, and the mechanical switch is arranged to be operated by the user, thereby inputting the setting information.

In the embodiment described above, the flowchart representing the control method of the projector 1 is not limited to the flowcharts shown in FIGS. 3 through 7.

For example, it is also possible to adopt a configuration in which the sound power supply device 62 is made to supply the sound processing device 8 with the electrical power to set the projector to be in the sound output state immediately after the user inputs the setting information (for setting the NWSTB mode to be “valid” and the MicSTB mode to be “valid”) to the operation device 4, and the projector transfers to the MicSTB mode. In other words, when setting the projector to be in the sound output state, detection of the connection state (the connection between the output plug of the external microphone and the microphone jack MJ) and the detection of the input state (the input of the microphone sound signal) can also be omitted.

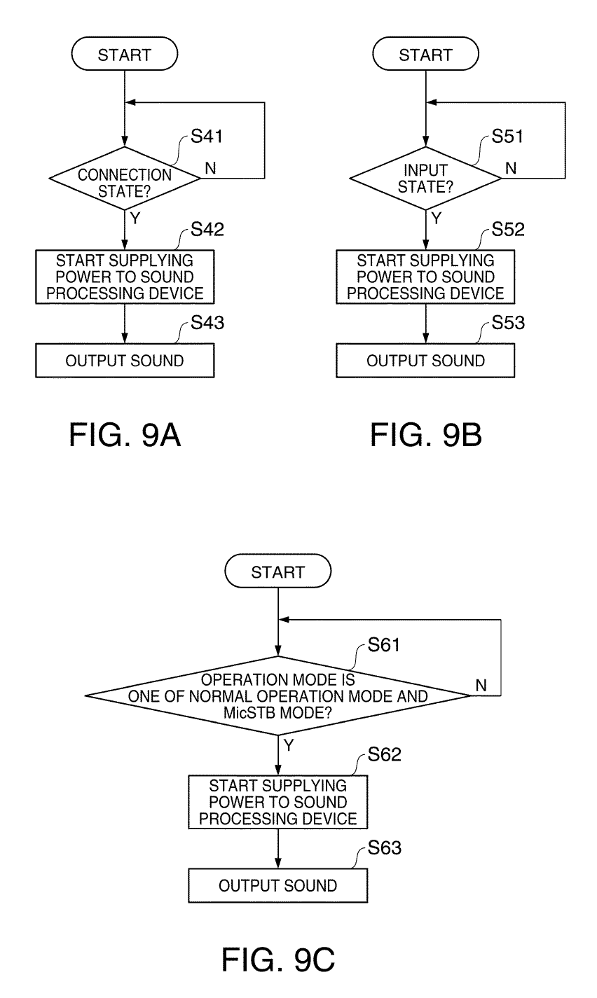

Further, as shown in FIG. 9A, for example, it is also possible to adopt a configuration in which the sound power supply device 62 is made to supply the sound processing device 8 with the electrical power in the step S42 immediately after the connection state is detected in the step S41, and then the projector is set to be in the state capable of the sound output in the step S43. It should be noted that when setting the projector to be in the sound output state, it is also possible to omit input (setting of the operation mode) of the setting information to the operation device 4 and detection of the input state.

Further, as shown in FIG. 9B, for example, it is also possible to adopt a configuration in which the sound power supply device 62 is made to supply the sound processing device 8 with the electrical power in the step S52 immediately after the input state is detected in the step S51, and then the projector is set to be in the sound output state in the step S53. It should be noted that when setting the projector to be in the sound output state, it is also possible to omit input (setting of the operation mode) of the setting information to the operation device 4 and detection of the connection state.

Alternately, as shown in FIG. 9C, it is also possible to adopt a configuration in which the sound power supply device 62 is made to supply the sound processing device 8 with the electrical power in the step S62 in the case in which it is detected in the step S61 that the operation mode is the normal operation mode or the MicSTB mode, and then the projector is set to be in the state capable of the sound output in the step S63. In this case, it is also possible to omit the detection of the connection state and the input state. According to such a configuration, the circuit for detecting the connection state and the input state becomes unnecessary, and thus the product cost can be reduced.

Further, although only the power supply to the amplifying section 82 is halted in the post-output process, for example, this is not the limitation, but it is possible to adopt a configuration in which the power supply to the signal processing section 81 is also halted.

In the embodiment described above, the configuration of the connection detection device 7 is not limited to the configuration explained in the embodiment described above.

For example, in the case in which the external microphone is a USB microphone, it is also possible to adopt a configuration as the connection detection device, in which presence or absence of the supply of the BUS power to the external microphone, thereby detecting whether or not the external microphone is connected.

Although in the embodiment, the signal processing section 81 is adopted as the input detection device according to the invention, this is not the limitation, but it is also possible to separately provide other devices besides the signal processing section 81 providing the signal level of the microphone sound signal is detected with the configuration.

Although in the embodiment, there is adopted the configuration in which the thermistor 622A detects the temperature of the amplifier power supply section 622, this is not the limitation, but it is also possible to adopt a configuration in which the temperature of at least either one of the sound power supply device 62 and the sound processing device 8 is detected.

Although in the embodiment described above, there is adopted the configuration in which the microphone sound signal is input when the output plug of the external microphone is inserted into the microphone jack MJ, this is not the limitation, but it is also possible to adopt a configuration in which the microphone sound signal is input from the external microphone via a wireless medium.

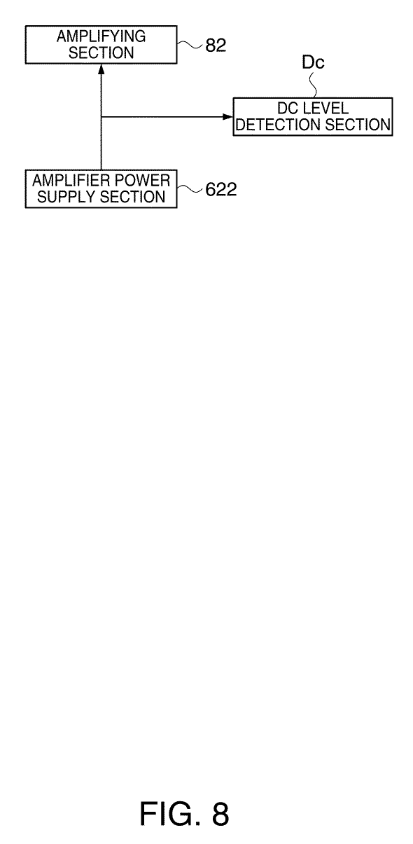

FIG. 8 is a diagram showing a modified example of the present embodiment.

Although in the embodiment described above, the thermistor 622A is adopted as the load detection device according to the invention, this is not the limitation, but it is also possible to adopt a DC level detection section Dc shown in FIG. 8.

Specifically, the DC level detection section Dc detects a DC level of the electrical power supplied from the amplifier power supply section 622 to the amplifying section 82.

In other words, since the heavier the load of the amplifier power supply section 622 is, the lower the voltage supplied to the amplifying section 82 is, and the lighter the load is, the higher the voltage supplied to the amplifying section 82 is, the state of the load of the amplifier power supply section 622 can be detected by the DC level detection section Dc detecting the DC level.

In the embodiment described above, the cooling objects of the cooling devices 5 are not limited to the cooling objects (the light source device 21, the light modulation device 23, the light source driving section 22, and the power supply devices 6) explained in the embodiment described above, but other cooling objects can also be adopted.

Although in the embodiment described above, the cooling fans 511, 521, 531 are adopted as the cooling devices 5, they are not the limitation, but it is also possible to adopt a configuration of cooling the cooling objects by other constituents such as a circulating liquid coolant.

Although in the embodiment described above, the discharge emission light source lamp is adopted as the light source device 21, this is not the limitation, but it is also possible to adopt various types of solid state light emitting elements such as a laser diode, a light emitting diode (LED), an organic electroluminescence (EL) element, or a silicon light emitting element.

In the embodiment described above, it is also possible to adopt a digital micromirror device (DMD, a trademark owned by the Texas Instruments (United States)) and soon as the light modulation device 23, besides a transmissive liquid crystal panel and a reflective liquid crystal panel.

Although in the embodiment described above, only an example of the front type projector for performing projection from the direction in which the screen is observed is cited, the invention can be applied to rear projectors for performing projection from the direction opposite to the direction in which the screen is observed.

The projector according to the invention can achieve enhancement of convenience, and therefore, can be used for a projector used for presentations or a home theater.

What is claimed is:

1. A projector comprising:
a power supply device;
an image projection device having alight source device;
a sound processing device adapted to process a sound signal from an external microphone; and
a control device adapted to control the power supply device,
wherein the control device can selectively set either one of a first operation mode in which the light source device and the sound processing device are made to be supplied with electrical power and a second operation mode in which the sound processing device is made to be supplied with the electrical power while halting supplying the electrical power to the light source device, and
the control device controls the electrical power supply by the power supply device to the light source device and the sound processing device based on the operation mode set.

2. The projector according to claim 1, wherein
the control device can further set a third operation mode in which electrical power supply to the light source device and the sound processing device is halted.

3. The projector according to claim 1, further comprising:
an operation device adapted to allow input of setting information for setting the operation mode,
wherein the control device determines the operation mode based on the setting information.

4. The projector according to claim 1, further comprising:
a microphone jack to which an output plug of the external microphone is inserted, and adapted to output the sound signal from the external microphone to the sound processing device; and
a connection detection device adapted to detect a connection state in which the output plug is inserted into the microphone jack, and a non-connection state,
wherein the control device makes the power supply device supply the sound processing device with the electrical power, in a case in which the operation mode is set to be either one of the first operation mode and the second operation mode, and the connection detection device detects the connection state.

5. The projector according to claim 4, wherein
the control device makes the power supply device halt the electrical power supply to the sound processing device irrespective of the detection result in the connection detection device in a case in which the operation mode is set to be the third operation mode.

6. The projector according to claim 1, further comprising:
an input detection device adapted to detect an input state in which the sound signal is input from the external microphone, and a non-input state,
wherein the control device makes the power supply device supply the sound processing device with the electrical power, in a case in which the operation mode is set to be either one of the first operation mode and the second operation mode, and the input detection device detects the input state.

7. The projector according to claim 1, wherein
the power supply device includes a sound power supply device adapted to supply the sound processing device with the electrical power,
the projector further includes
a load detection device adapted to detect a load state of the sound power supply device, and
a cooling device adapted to cool the sound power supply device, and
the control device includes
a cooling control section adapted to control the cooling device based on the load state.

8. The projector according to claim 7, wherein
the sound processing device processes the sound signal with a gain corresponding to a volume value set previously, and
the control device includes
a volume control section adapted to vary the gain in accordance with an operation state of the cooling device.

9. The projector according to claim 1, further comprising:
a temperature detection device adapted to detect temperature of at least either one of the sound processing device and the sound power supply device,
wherein the control device makes the electrical power supply from the sound power supply device to the sound processing device be halted, in a case in which the operation mode is set to be either one of the first operation mode and the second operation mode, and the temperature is one of equal to and higher than a predetermined threshold value.

10. The projector according to claim 1, further comprising:
a cooling device adapted to cool at least either one of the sound processing device and the sound power supply device,
wherein the control device includes
a cooling control section adapted to make the cooling device operate in a case in which the temperature is one of equal to and higher than the predetermined threshold value, and
the control device restarts the electrical power supply to the sound processing device in response to the temperature becoming lower than the predetermined threshold value after the cooling device is made to operate and the electrical power supply to the sound processing device is once halted.

11. A method of controlling a projector, comprising:
providing a power supply device, an image projection device having a light source device, a sound processing device adapted to process a sound signal from an external microphone, and a control device adapted to control the power supply device;
selectively setting either one of a first operation mode in which the light source device and the sound processing device are made to be supplied with electrical power and a second operation mode in which the sound processing device is made to be supplied with the electrical power while halting supplying the electrical power to the light source device; and
controlling the electrical power supply by the power supply device to the light source device and the sound processing device based on the operation mode set.
